(19) United States
(12) Patent Application Publication
(10) Pub. No.: US 2007/0289220 A1
(43) Pub. Date: Dec. 20, 2007

(54) Window lock and sash

(75) Inventor: Kevin D. Vilhauer, Puyallup, WA (US)

Correspondence Address: FOLEY & LARDNER LLP, 777 EAST WISCONSIN AVENUE, MILWAUKEE, WI, 53202-5306, US

(73) Assignee: Milgard Manufacturing Incorporated

(21) Appl. No.: 11/445,688

(22) Filed: Jun. 2, 2006

(51) Int. Cl. E05B 55/00

(52) U.S. Cl. 49/449

(57) ABSTRACT

A window includes at least one movable sash having a horizontal rail with a horizontal top portion and a vertical portion extending downward from the horizontal top portion. A pull rail portion extends from the horizontal rail beyond the vertical portion. A latch is located below the pull rail and adjacent the vertical portion. The latch includes a pull handle configured to release a latching mechanism from one of a second sash or a frame.

### CROSS-REFERENCE TO RELATED PATENT APPLICATIONS

None.

### BACKGROUND OF THE INVENTION

The present invention relates generally to the field of window locks, and more particularly to an improved window latch located under a sash. A window latch secures a window sash when it is in the closed. In sliding windows, where a window sash is slid relative to another sash, the latch is first released in order to slide the window to the open position. The window latch is typically placed on top of the movable sash and engages and disengages a latch plate on the other sash or window frame to lock and unlock the window. A window sash may also have a pull rail that extends outwardly to assist a user in opening and closing the movable sash. Accordingly, it would be advantageous to provide a window sash with both a pull rail and a front facing latch.

Often, when a user manipulates a latch for a window, the user slides the moveable sash by grasping the latch, imparting substantial stress on the latch perpendicular to the surface of the window (by pulling out or pushing in on the latch to disengage the locking mechanism) and in the direction of travel (by pulling on the latch to slide the sash). A user may also impart a substantial moment on the latch by grasping it “off-center.” Accordingly, it would be advantageous to locate the latch such that a force applied to it by the user is resisted by structural elements of the window.

### SUMMARY OF THE INVENTION

One embodiment of the invention relates to a window includes at least one movable sash having a horizontal rail with a horizontal top portion and a vertical portion extending downward from the horizontal top portion. A pull rail portion extends from the horizontal rail beyond the vertical portion. A latch is located below the pull rail and adjacent the vertical portion. The latch includes a pull handle configured to release a latching mechanism from one of a second sash or a frame.

In another embodiment, a window sash and latch includes a first sash with first and second spaced rails and a second pair of spaced rails being perpendicular to the first and second rails. A glazing is located between the first and second rails and the second pair of spaced rails. A latch is operatively connected to the first rail. The first rail includes a first surface extending perpendicular to the glazing and includes a pull rail extending therefrom in a direction away from the glazing. The latch is located adjacent a first surface of the first rail that is parallel to the glazing and located adjacent the pull rail. The latch includes a handle configured to release a latching mechanism from a second sash.

In a further embodiment a window includes a movable sash with a first rail and a second spaced rail parallel to the first rail. A glazing is located between the spaced rails. A pull rail extends from the first rail away from the glazing. The pull rail has a first surface facing away from the second rail and a second surface opposite the first surface facing toward the second rail. A latch is operatively coupled to the movable sash to releasably lock the movable sash relative to one of a second sash or a frame. The latch is located adjacent the first rail and adjacent the second surface of the pull rail.

### BRIEF DESCRIPTION OF THE DRAWINGS

FIG. 1 is an isometric view of a window according to an exemplary embodiment in a closed and locked configuration.

FIG. 2 is a partial isometric view of the window in FIG. 1.

FIG. 3 is a partial cross-section of the window in FIG. 1 taken generally along line 2-2 of FIG. 1.

### DETAILED DESCRIPTION OF THE PREFERRED EMBODIMENTS

Before providing the description of the exemplary embodiments of the window lock and sash, it should be noted that the references to “up,” “upper,” rear,” “front,” “inner,” and “outer” in this description are merely used to identify the various elements as they are oriented in the Figures and in relation to a particular embodiment of a window with vertically sliding portions, or sashes. The terms “up” and “upper” are used to reference a general vector direction away from the force of gravity or the direction a moveable sash moves as it is opened relative to a second sash. The term “rear” is used to describe the surface of the first sash that is proximate to or closer to the second sash, while the term “front” is used to describe the surface that a person would see facing the window from inside of a building structure. The term “inner” is used to reference a direction towards the interior and a person using the window, while the term “outer” is used to reference a direction towards the exterior and away from a person using the window.

It should also be noted that the term “rail” as used in the description describes the horizontal rail on the sash. However, when the latch mechanism is used on a horizontal sliding window, the term “stile” would be more appropriate. In the case of a horizontal sliding window, the term “up” would be the direction the first sash moves as the first sash is being opened relative to the second sash.

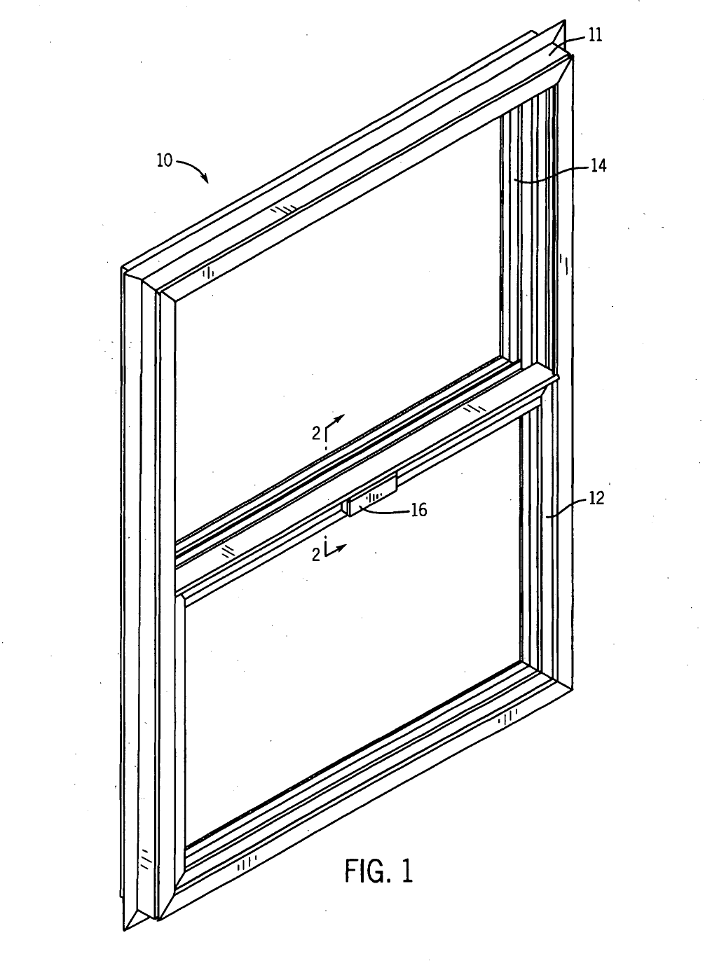

Referring to FIG. 1, a window 10 is shown according to an exemplary embodiment comprising a frame 11, a first movable sash 12, a second sash 14, and a latch 16. Moveable sash 12 and sash 14 are generally mounted in frame 11 and allowed to slide vertically in frame 11 with moveable sash 12 sliding on an first, or inner track and sash 14 sliding on a second or outer track. Latch 16 is coupled to movable sash 12 and releasably engages sash 14. According to an exemplary embodiment, window 10 is vertically sliding window or a “double hung” window. According to other exemplary embodiments, the second sash may be fixed or “single hung” window. According to still other exemplary embodiments, the window could be a horizontally sliding window.

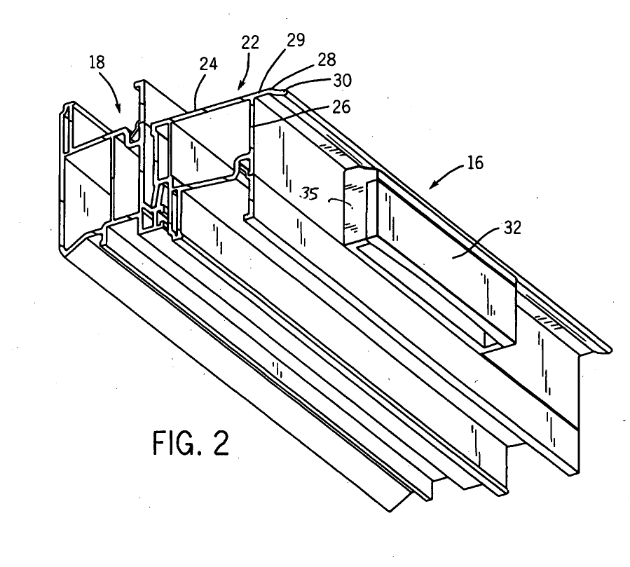

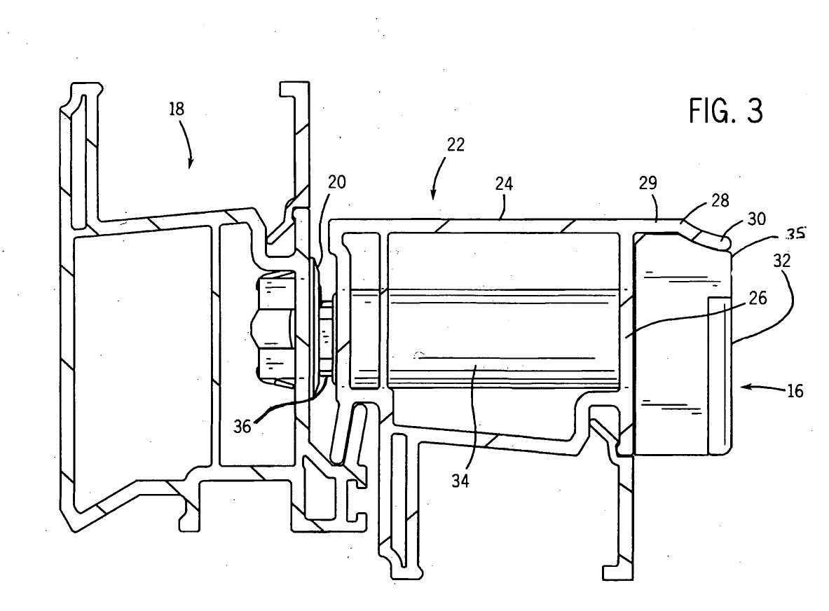

Referring now to FIGS. 2-3, a portion of window 10 is shown according to an exemplary embodiment, focusing on the portion of window 10 where moveable sash 12 and sash 14 are coupled when window 10 is in a locked configuration. Movable sash 12 includes an upper horizontal rail 22 that defines the upper edge of moveable sash 12 and comprises an upper horizontal wall 24, a front vertical wall 26, and a pull rail 28. Pull rail 28 is a protrusion (lip, rim, ledge, etc.) that provides a convenient structure for a user to use to raise and or lower the movable sash 12. Pull rail 28 extends away from horizontal wall 24 in an inward direction defined by a vector extending from sash 14 toward the movable sash 12. The inward direction is defined by the direction from the window toward the user as the user faces the window. In an exemplary embodiment pull rail 28 extends beyond vertical wall 26 in the inward direction and comprises a first portion 29 that is generally horizontal and continuous with horizontal wall 24, and a second portion 30 that curves and/or angles downward. Other configuration of a pull rail that provides a user with a surface to lift the sash are also contemplated.

Sash 14 includes a lower horizontal rail 18 that defines the lower edge of sash 14. Horizontal rail 18 includes a feature, shown schematically as latch plate 20 that is configured to receive a locking mechanism or portion of latch 16 as described in greater detail below.

Latch 16 is operatively coupled to vertical wall 26 of moveable sash 12 below pull rail 28 and is configured to selectively releasably couple and lock moveable sash 12 to sash 14. As noted above latch 16 may be used on a sliding window including horizontal sliding windows and vertical sliding windows. While the latch 16 may be used with different types of sliding windows including those identified above, latch 16 will be described relative to a vertical sliding window. Latch 16 includes a handle 32, a bezel or housing 35, a main body 34, and a locking mechanism 36, shown schematically in FIG. 3 as a bolt. Main body 34 houses a mechanism to transfer user input to locking mechanism 36 and, according to an exemplary embodiment, is mounted in horizontal rail 18. Locking mechanism 36 engages latch plate 20 and prevents moveable sash 12 from sliding vertically relative to sash 14. To unlock window 10, user manipulates handle 32 (e.g. by pushing, pulling, or pivoting) which disengages locking mechanism 36 and allows moveable sash 12 to slide relative to sash 14. Handle 32 is shown schematically in the Figures. Handle 32 may be pivotally attached to bezel 35 or may be configured to be pushed or pulled relative to bezel or housing 35. Further handle 32 may include a slideable mechanism and movable back and forth relative to the frame in a direction parallel to the glazing.

The location of latch 16 under pull rail 28 provides resistance to movement for latch 16 on at least three sides or directions. However, latch 16 may be supported in more or less vector directions as well. In an exemplary embodiment latch 16 is supported on the rear by vertical wall 26, on the top by pull rail 28, and on the front by second portion 30 of pull rail 28. The location of latch 16 proximate to pull rail 28 allows a substantial portion of the force placed on it by a user to be resisted by the structure of the sash itself instead of by latch 16. A force applied by a user on latch 16 by pulling latch 16 to disengage locking mechanism 36 is resisted by second portion 30 of pull rail 28. An upward force applied by a user on latch 16 by pulling up on latch 16 to slide moveable sash 12) is resisted by pull rail 28. A force applied by a user on latch 16 by pushing may be resisted by a portion of vertical wall 26.

It is important to note that the construction and arrangement of the latch and sash as described herein is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements and vice versa, the position of elements may be reversed or otherwise varied, and the nature or number of discrete elements or positions may be altered or varied. Accordingly, all such modifications are intended to be included within the scope of the present invention as defined in the appended claims. Further, the latch may be centrally located between two ends of the rail or maybe located off center. Additionally, there may be one or more latches on a single movable sash. The order or sequence of any process or method steps may be varied or re-sequenced according to alternative embodiments. Other substitutions, modifications, changes and omissions may be made in the design, operating conditions and arrangement of the exemplary embodiments without departing from the scope of the present inventions as expressed in the appended claims.

What is claimed is:

1. A window sash and latch comprising:
a window having at least one movable sash having a horizontal rail;
the horizontal rail including a horizontal top portion and a vertical portion extending downward from the horizontal top portion;
a pull rails portion extending from the horizontal rail beyond the vertical portion; and
a latch being located below the pull rail and adjacent the vertical portion, the latch including a pull handle configured to release a latching mechanism from one of a second sash or a frame.

2. The window sash and latch of claim 1, wherein the pull rail includes a first substantially horizontal extension portion and a second extension portion extending therefrom at a non horizontal direction.

3. The window sash and latch of 2, wherein the non-horizontal extension portion extends at a downward angle.

4. The window sash and latch of claim 3, wherein the latch includes an upper member that is located adjacent to the horizontal and non-horizontal extension portions.

5. The window sash and latch of claim 4, wherein the latch includes a housing and a pull handle pivotally attached to the housing.

6. The window sash and latch of claim 5, wherein the handle pivots upwardly and away from the sash to activate the lath.

7. The window sash and latch of claim 1, wherein the pull rail extends substantially across the entire width of a glazing in the movable sash.

8. A window sash and latch comprising:
a first sash having a first and second spaced rails and a second pair of spaced rails being perpendicular to the first and second rails;
a glazing being located between the first and second rails and the second pair of spaced rails; and
a latch being operatively connected to the first rail; the first rail including a first surface extending perpendicular to the glazing and including a pull rail extending therefrom in a direction away from the glazing, the latch being located adjacent a first surface of the first rail that is parallel to the glazing and located adjacent the pull rail, the latch including a handle configured to release a latching mechanism from a second sash.

9. The window sash and latch of claim 8, wherein the pull rail includes a first extension portion substantially perpendicular to the glazing.

10. The window sash and latch of 9, wherein the pull rail includes a second portion extending from the first portion toward the latch.

11. The window sash and latch of claim 10, wherein the latch includes a housing that is located adjacent to the first and second extension portions of the pull rail.

12. The window sash and latch of claim 11, wherein the handle is pivotally attached to the housing.

13. The window sash and latch of claim 12, wherein the handle pivots from away from the glazing to unlock the first sash from a second sash.

14. The window sash and latch of claim 8, wherein the pull rail extends substantially across the entire width of a glazing in the movable sash.

15. A window sash and latch comprising:
a movable sash including a first rail and a second spaced rail parallel to the first rail, a glazing being located between the first and second rails;
a pull rail extends from the first rail away from the glazing, the pull rail having a first surface facing away from the second rail and a second surface opposite the first surface facing toward the second rail;
a latch being operatively coupled to the movable sash to releasably lock the movable sash relative to one of a second sash or a frame; the being located adjacent the first rail and adjacent the second surface of the pull rail.

16. The window sash and latch of claim 15, wherein a force applied to the latch to move the movable sash to the open position is transferred to the pull rail.

17. The window sash and latch of claim 16, wherein the pull rail includes a first portion and a second portion nonplanar to the first portion.

18. The window sash and latch of claim 15, wherein the pull rail extends substantially across the first rail.

19. The window sash and latch of claim 15 further, wherein the latch extends through the first rail and into a portion of the second rail in a locked position.

20. The window sash and latch of claim 15, wherein the latch is centrally located on the first rail.
